(19) United States
(12) Patent Application Publication
(10) Pub. No.: US 2012/0196580 A1
(43) Pub. Date: Aug. 2, 2012

(54) METHODS AND APPARATUSES FOR TACTILE CALLER IDENTIFICATION IN HEARING-IMPAIRED COMMUNICATION SYSTEMS

(75) Inventors: Richard Lee Simmons, West Jordan, UT (US); Todd Lane Ouzts, Draper, UT (US); Loren Douglas Larsen, Lindon, UT (US)

(73) Assignee: SORENSON COMMUNICATIONS, INC., Salt Lake City, UT (US)

(21) Appl. No.: 13/016,243

(22) Filed: Jan. 28, 2011

(51) Int. Cl. H04W 4/16

(52) U.S. Cl. 455/415

(57) ABSTRACT

Methods and apparatuses for indicating an incoming call on a portable communication device are disclosed. A calling connection indicator is captured from an incoming call. An identified entry is selected from a caller identification list comprising one or more entries, wherein each of the entries is associated with a contact of a user of the portable communication device and includes one or more connection indicators for the contact and a tactile pattern for the contact. The identified entry is selected by matching the calling connection indicator to one of the one or more connection indicators. A tactile pattern is generated for the portable communication device. The tactile pattern includes a predefined tactile pattern associated with the identified entry in the caller identification list or a default tactile pattern if the calling connection indicator does not correlate to any of the connection indicators in the caller identification list.

### TECHNICAL FIELD

The invention discussed herein relates generally to video phone communication systems, and more specifically, to methods and apparatuses for providing tactile information about a caller to persons less reliant on audible indications, such as hearing-impaired persons.

### BACKGROUND

The use of indicators for identifying the activation of a device is commonplace. One predominant form of indicators utilizes an audible or sound-based mechanism for providing notification to a user. However, some persons may have impaired hearing capabilities and may even be completely deaf to audible indicators. Accordingly, such individuals are at a distinct disadvantage to detect and respond to such audible indicating devices.

One such device that has traditionally relied upon an audible indicator is a telephone or similar telecommunications device. Such devices have conventionally utilized a bell, speaker, or other audible device for notification to a user of an incoming call. For hearing-impaired users, or in environments that are not conducive to audible indicator detection, visual indicators have been developed. One known visual indication approach utilized by hearing-impaired users for identifying an incoming telephone call is illustrated with reference to FIG. 1. This prior approach connects a telephone 10 through a coupling circuit 12 to a room lamp 14 or other light source. The coupling circuit 12, upon detection of a telephone “ring” signal on a network 16, causes, for example, a room light or lamp 14 to flash repeatedly when a ringing voltage or other signal designates an incoming call.

In such applications, and to the hearing-impaired community, telephone-coupling circuits and single light source visual indicator have often been referred as “flashers.” Flashers or visual indicators may be implemented as a single light source located on or near the telephone or may be coupled to a more generally present light source such as a light bulb or lamp in a room inhabited by a hearing-impaired user. While such visual indicators provide notification to a user thereof, such visual indicators are “one dimensional” in information conveyed in that they provide only a notification of the occurrence of an event (e.g., the ringing of an incoming call).

While visual indicators exist that provide a visual indication of the origin of, for example, an incoming call, such visual notifications are generally not adequately able to alert and may readily go unnoticed. For example, FIG. 2 illustrates a conventional telephone 20 configured with a caller identification display 22 that provides a visual notification of an incoming call and even provides information correlated to the calling party. However, while the caller identification display 22 is configured to provide correlated information of the calling party it is not adequately visually alerting to draw attention to the telephone device.

Electronic portable communication devices may be hidden from view such as in a pocket or purse. In such a situation, a visual alerting mechanism may not be noticed by the user. For hearing-impaired users, or in environments that are not conducive to audible indicator detection, audible alert mechanisms may not be adequate in a portable communication device. Therefore, some portable communication devices include a vibration mechanism for the portable communication device to alert of an incoming call or other events for which an alert is desired. However, such vibration indicators only convey information of the event and include no information related to the identity of the caller.

Therefore, there is a need for methods and apparatuses that provide a tactile alerting mechanism for incoming calls, or other events for which an alert is desired, to portable communication devices and that also provide an indication of a caller's identity.

### BRIEF SUMMARY

Embodiments discussed herein include methods and apparatuses that provide a tactile alerting mechanism for incoming calls, or other events for which an alert is desired, to portable communication devices and that also provide an indication of a caller's identity.

In some embodiments, the present invention comprises a portable communication device including incoming caller identification logic, a caller identification list, association logic, and a tactile pattern generator. The incoming caller identification logic is configured to capture a calling connection indicator from an incoming call. The caller identification list is configured to store one or more entries, each of the one or more entries including one or more connection indicators associated with the entry and a predefined tactile pattern associated with the entry. The association logic is configured to determine an identified entry in the caller identification list by matching the calling connection indicator to the one or more connection indicators associated with the identified entry. The tactile pattern generator is configured to generate a plurality of tactile patterns for the portable communication device, the plurality of tactile patterns include the predefined tactile pattern associated with the identified entry in the caller identification list or a default tactile pattern if the calling connection indicator does not correlate to any of the one or more connection indicators in the caller identification list.

In other embodiments, the present invention comprises a method of indicating an incoming call on a portable communication device. The method includes capturing a calling connection indicator from an incoming call. An identified entry is selected from a caller identification list comprising one or more entries, wherein each of the one or more entries is associated with a contact of a user of the portable communication device and includes one or more connection indicators for the contact and a tactile pattern for the contact. The identified entry is selected by matching the calling connection indicator to one of the one or more connection indicators. The method also includes generating a tactile pattern for the portable communication device. The tactile pattern includes a predefined tactile pattern associated with the identified entry in the caller identification list or a default tactile pattern if the calling connection indicator does not correlate to any of the one or more connection indicators in the caller identification list.

In other embodiments, the present invention comprises a relay service for a hearing-impaired user. The relay service includes a caller identification list with one or more entries, each of the one or more entries associated with a contact of the hearing-impaired user and including one or more connection indicators for the contact and a predefined tactile pattern associated with the entry. The relay service also includes communication logic configured to convey information between the relay service and a portable communication device, the information including at least one of the one or more entries in the caller identification list.

### BRIEF DESCRIPTION OF THE SEVERAL VIEWS OF THE DRAWINGS

FIG. 1 is a simplified diagram of a conventional visual notification system;

FIG. 2 is a simplified diagram of another conventional visual notification system;

FIG. 3 is a simplified diagram of a visual notification system for use with a video conferencing system;

FIG. 4 illustrates a simplified block diagram illustrating a Video Relay Service (VRS) configured for operation with a hearing-impaired communication system in accordance with one or more embodiments of the invention;

FIG. 5 is a block diagram illustrating elements of a portable communication device in accordance with one or more embodiments of the invention;

FIG. 6 is a block diagram illustrating communication of caller identification information between a VRS and a portable communication device;

FIG. 7 is a block diagram illustrating entries in a caller identification list in accordance with one or more embodiments of the invention;

FIG. 8 is a block diagram of processing hardware that may be used in accordance with one or more embodiments of the invention; and

FIGS. 9A-9C illustrate graphical user interfaces that may be used in some embodiments discussed herein.

### DETAILED DESCRIPTION

In the following detailed description, reference is made to the accompanying drawings which form a part hereof, and in which is shown by way of illustration, specific embodiments in which the invention may be practiced. These embodiments are described in sufficient detail to enable those of ordinary skill in the art to practice the invention. It should be understood, however, that the detailed description and the specific examples, while indicating examples of embodiments of the invention, are given by way of illustration only and not by way of limitation. From this disclosure, various substitutions, modifications, additions rearrangements, or combinations thereof within the scope of the present invention may be made and will become apparent to those of ordinary skill in the art.

In accordance with common practice the various features illustrated in the drawings may not be drawn to scale. The illustrations presented herein are not meant to be actual views of any particular method, device, or system, but are merely idealized representations that are employed to describe various embodiments of the present invention. Accordingly, the dimensions of the various features may be arbitrarily expanded or reduced for clarity. In addition, some of the drawings may be simplified for clarity. Thus, the drawings may not depict all of the components of a given apparatus (e.g., device) or method. In addition, like reference numerals may be used to denote like features throughout the specification and figures.

Those of ordinary skill in the art would understand that information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

Those of ordinary skill would further appreciate that the various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and acts are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the invention described herein.

In addition, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on a computer-readable medium. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise, a set of elements may comprise one or more elements.

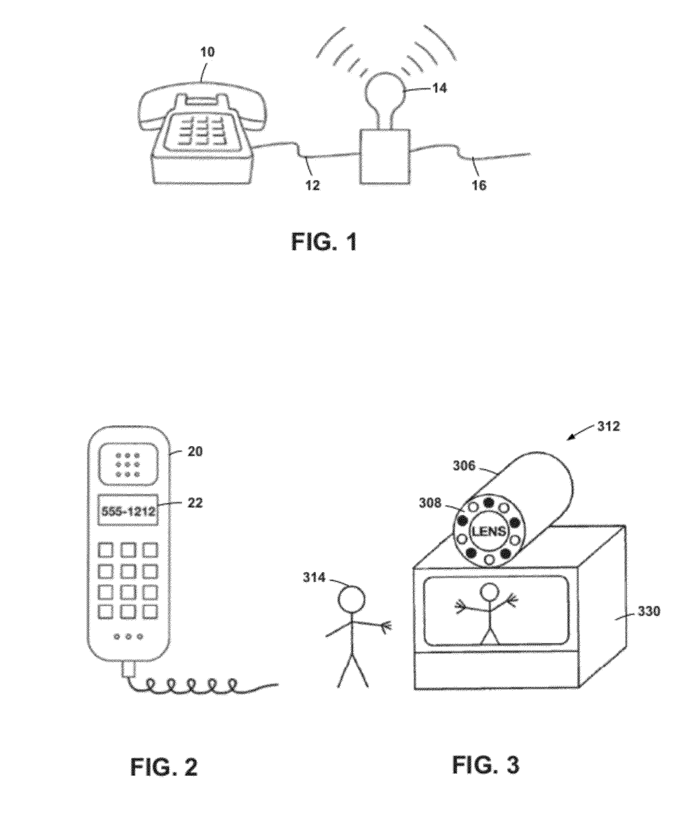

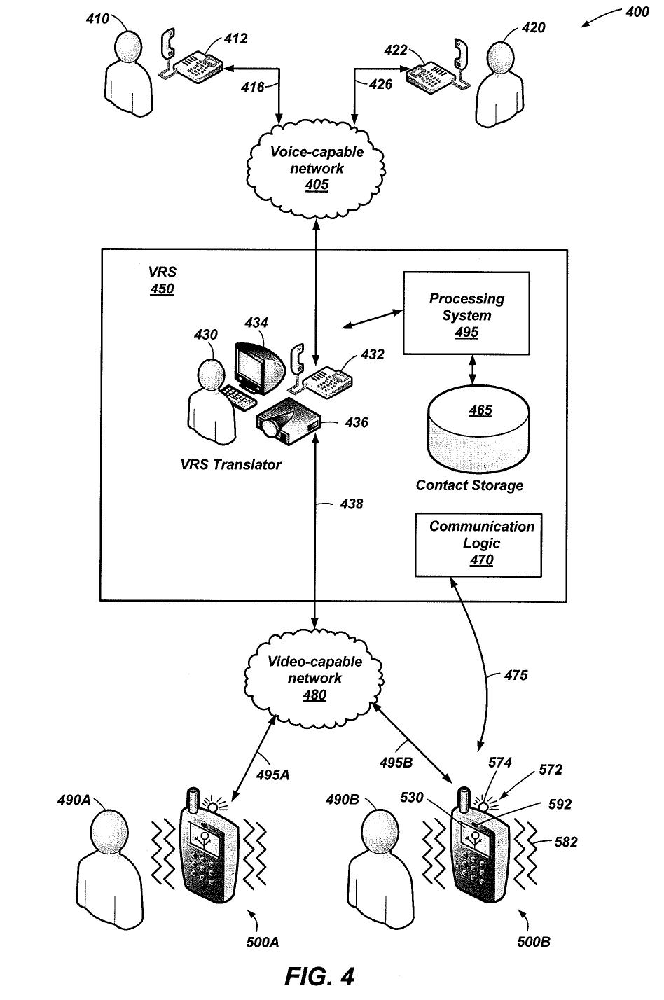

Elements described herein may include multiple instances of the same element. These elements may be generically indicated by a numerical designator (e.g. 110) and specifically indicated by the numerical indicator followed by an alphabetic designator (e.g., 110A) or a numeric indicator preceded by a “dash” (e.g., 110-1). For ease of following the description, for the most part, element number indicators begin with the number of the drawing on which the elements are introduced or most fully discussed. Thus, for example, element identifiers on a FIG. 1 will be mostly in the numerical format 1xx and elements on a FIG. 4 will be mostly in the numerical format 4xx.

Embodiments discussed herein include methods and apparatuses that provide a tactile alerting mechanism for incoming calls, or other events for which an alert is desired, to portable communication devices and that also provide an indication of a caller's identity. It should be noted that while the utility and application of the various embodiments of the present invention are described with reference to a hearing-impaired environment, the invention also finds application to any environment where a tactile indicator may be helpful or desirable.

The term “incoming call” refers to an incoming communication to a communication device such as a portable communication device. This incoming communication should be considered to include communications such as E-mail, text messages, instant messages, voice communications, and video communications.

FIG. 3 is a simplified diagram of a visual notification system for use with a video conferencing system. As previously stated, visual indicators for conventional audible indicating devices provide utility to hearing-impaired individuals who are physically incapable of detecting audible sounds or in situations where an audible indicator may be difficult to detect, such as in a noisy work environment. In FIG. 3, communicative expressions of a hearing-impaired user 314 within a communication system incorporates a visual indicator telephone system 312, an example of which includes a video phone 330 and a spatial visual indicator device 306, which further includes a spatial visual indicator 308. When a call is placed to the hearing-impaired user 314, the visual indicator telephone system 312 receives a calling connection indicator and indicates an incoming call. The spatial visual indicator device 306 captures the calling connection indicator from the incoming call and compares the information with entries in a stored caller identification list to determine if a match with the calling connection indicator exists. If a match exists, the spatial visual indicator 308 provides visual indication of an identity of the caller, such as, for example, flashes of lights in a predefined pattern. Such a system is described in detail in U.S. Pat. No. 7,769,141 to Cupal et al., the contents of which is hereby incorporated by reference in its entirety.

FIG. 4 illustrates a simplified block diagram illustrating a Video Relay Service (VRS) 450 configured for operation with a portable communication device 500 in accordance with one or more embodiments of the invention. The communication system 400 includes one or more portable communication devices 500 (one system shown in FIG. 4 for clarity), one or more voice-capable communication systems 412, 422 and a VRS 450 (also referred to herein as a relay service 450).

A hearing-capable user 410, 420 may use voice-capable equipment 412, 422 to communicate with the VRS 450 through a voice-capable connection 416, 426 to a voice-capable network 405. Two hearing-capable users 410, 420 are illustrated to indicate that each of the hearing-capable users 410, 420 may have different indicator patterns associated with them as is explained below.

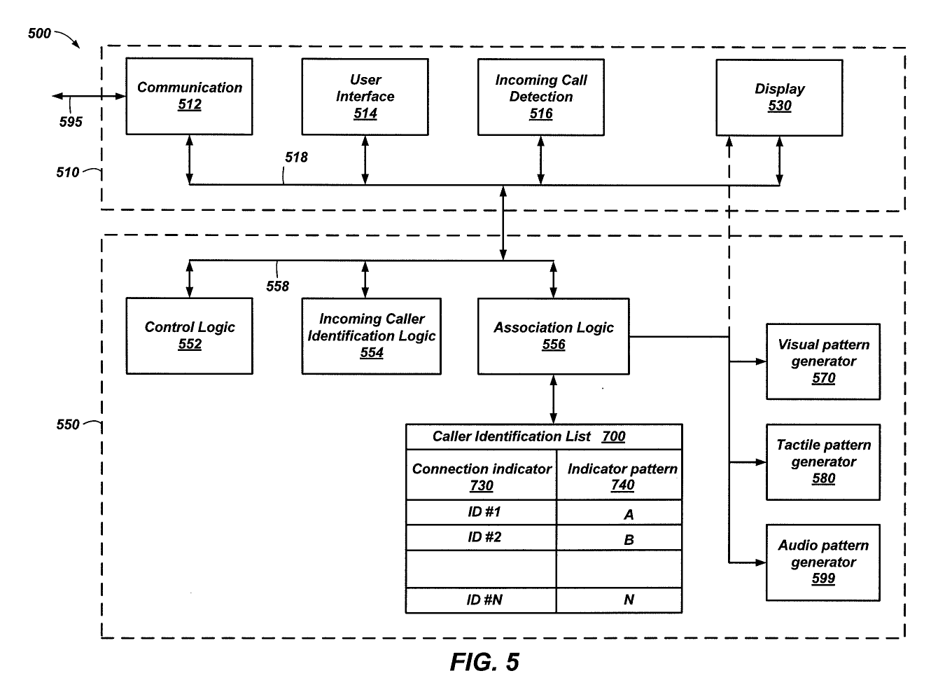

A hearing-impaired user 490A, 490B may use a portable communication device 500A, 500B to communicate with the VRS 450 through a wireless network 495A, 495B. In some embodiments, the portable communication device 500 may be video-capable equipment 500, which may communicate over a wireless network 595 (FIG. 5) that is also a video-capable network 480.

Wireless networks may include any network using wireless electromagnetic signals, such as, for example, Wi-Fi, cellular phone networks, BLUETOOTH®, Zigbee, and near-field communication, that is capable of carrying information including at least audio signals and, in some embodiments, video signals.

As used herein, voice-capable networks 405 and voice-capable equipment 412, 422 means networks and equipment that can process, convey, reproduce, or a combination thereof, sounds in the auditory frequencies as analog signals, digital signals or a combination thereof. As non-limiting examples, such equipment includes conventional telephones, conventional cellular telephones, and conventional computers or handheld devices with microphone and speaker type capabilities. As non-limiting examples, such networks include a telephone network such as the Public Switched Telephone Network (PSTN) and other networks that are compatible and configured to provide communications using digital standards and data packets, an example of which includes Voice Over Internet Protocol (VOIP).

As used herein, video-capable networks 480 and video-capable equipment 500 means networks and equipment that can process, convey, reproduce, or a combination thereof, multi-frame images. As non-limiting examples, such equipment includes conventional cellular telephones with video capability, and conventional computers or handheld devices with camera and display type capabilities. As non-limiting examples, such networks include cellular networks, WiFi networks, wide area networks, hard wired networks and other private data networks configured to provide communications using digital standards and data packets. To facilitate the enhanced bandwidth needs of video phones 500, the video-capable network 480 may be implemented as a high bandwidth network such as a Digital Subscriber Line (DSL), Cable, Ethernet, 3G cellular networks, 4G cellular networks, and other enhanced-bandwidth networking technology.

In general, most video-capable networks 480 would be considered to also be voice-capable networks 405 and most video-capable equipment 500 would also be considered to be voice-capable equipment 412.

The portable communication device 500 can present a variety of predefined tactile patterns 582 to the hearing-impaired user 490. In some embodiments, the portable communication device 500 may also present audible indicators through a speaker or other suitable audio connection. The audible indicators may be conventional ringtones that may be customized to identified callers or they may be a predefined audible pattern 592 correlated to the predefined tactile patterns 582. In some embodiments, the portable communication device 500 may also present a variety of predefined visual patterns 572 correlated to the predefined tactile patterns 582. These visual patterns 572 may be presented to the user through an illumination device 574 or a display 530.

Within the VRS 450, a processing system 495 answers calls from hearing-capable users 410, 420 through calling connections 416, 426 and routes them to a translator 430 or places them in a queue (not shown) for subsequent servicing by a translator 430. The incoming calls include a calling connection indicator such as, for example, a telephone number, an Internet Protocol (IP) address, a website address or other unique indicator that indicates how the connection is made and from where the connection is made.

The processing system 495 may also query a caller identification list in contact storage 465 to determine indicator patterns associated with the hearing-capable user 410, 420 by placing the call in response to a calling connection indicator, as is explained more fully below in the descriptions of FIGS. 5-7.

Each translator 430 for the VRS 450 has voice-capable equipment 432 for communication with the hearing-capable user 410, 420 and video-capable equipment 436 for communication with the hearing-impaired user 490 in a suitable gesture language. A computer 434 or other processing hardware may be used in conjunction with, or instead of, stand-alone voice-capable equipment 432 and video-capable equipment 436. For example, the translator 430 may use a computer 434 coupled to a camera, a microphone, and speakers or headphones for all the communications.

If a gesture language is to be used in the relay service, the translator 430 connects to the hearing-impaired user 490 (may also be referred to herein as a deaf user) with a video-capable connection 438 through the video-capable network 480, a wireless network 595, and a video phone 500 for the hearing-impaired user 490. If a gesture language is not used in the relay service, the translator 430 may connect to the hearing-impaired user 490 with a video-capable connection 438 through the voice-capable network 405, a wireless network 595, and a portable communication device 500 that may not include video capability for the hearing-impaired user 490. When configured for video, the portable communication device 500 may include a camera for capturing outgoing image sequences suitable for person-to-person communication using gestures and a display suitable for presenting to the user incoming image sequences suitable for person-to-person communication using gestures.

The contact storage 465 maintained at the VRS 450 may be created, modified and updated by the hearing-impaired user 390 through a network connection 475 to communication logic 470 in the VRS 450. This network connection may be any suitable network, such as for example the Internet, and if different from the Internet, the voice-capable network 405 or the video-capable network 480. The communication logic 470 may also include tools such as web pages for viewing, updating and managing a caller identification list (e.g., information in the contact storage 465) by and for the hearing-impaired user 390. The caller identification list may also be held in storage in the portable communication device 500.

In another communication operation, one hearing-impaired user 490A may communicate through wireless network 495A with another hearing-impaired user 490B through wireless network 495B without using the VRS 450. Moreover, while the users have been defined as hearing impaired, in a direct communication that does not need the VRS 450, one or both of the users 490A, 490B may be hearing-capable users.

FIG. 5 is a block diagram illustrating elements of a portable communication device 500 in accordance with one or more embodiments of the invention. Some conventional functions of a portable communication device 500 are shown in communication block 510. These functions may include a communication element 512 for communication with one or more wireless networks 595, a user interface 514, incoming call detection logic 516, and the display 530. Interface bus 518 illustrates that these various functions may communicate through electrical signals, software signals, or combinations thereof.

Some functions, devices, and processes performed by one or more embodiments of the invention are illustrated in an identification block 550. Some of these elements include control logic 552, incoming caller identification logic 554, association logic 556, a caller identification list 700 stored in a contact storage (not shown in FIG. 5), a visual pattern generator 570, a tactile pattern generator 580, and an audio pattern generator 599. Interface bus 558 illustrates that these various functions may communicate through electrical signals, software signals, or combinations thereof. Moreover, the functions of the identification block 550 may communicate with the functions of the communication block 510. It should be understood that many signals, buses, and variables may be used and interface buses 518 and 558 merely illustrate that such communication between functions may occur rather than imply a specific type of communication.

In addition, the portable communication device 500 may include a microprocessor or other suitable processing hardware along with memory for carrying out computing instructions for some of the functions described herein. As a result, it should be understood that the functional blocks and “logic” described herein may include hardware, software, or a combination thereof.

When a call is received by the portable communication device 500, the incoming call detection logic 516 may detect the incoming call and notify the incoming caller identification logic 554, the control logic 552, or a combination thereof. The incoming caller identification logic 554 determines a calling connection indicator for the incoming call such as, for example, a telephone number, an Internet Protocol (IP) address, a website address or other unique indicator that indicates how the connection is made and from where the connection is made.

When the VRS 450 (FIG. 4) is used to contact the portable communication device 500, the calling connection indicator may be signified by communications with the VRS 450 rather directly determined based on the incoming call because the calling connection indicator that is desired is not for the VRS 450. Rather, the calling connection indicator that is desired is for the hearing-capable user 410, 420 for which the VRS 450 is acting as a proxy.

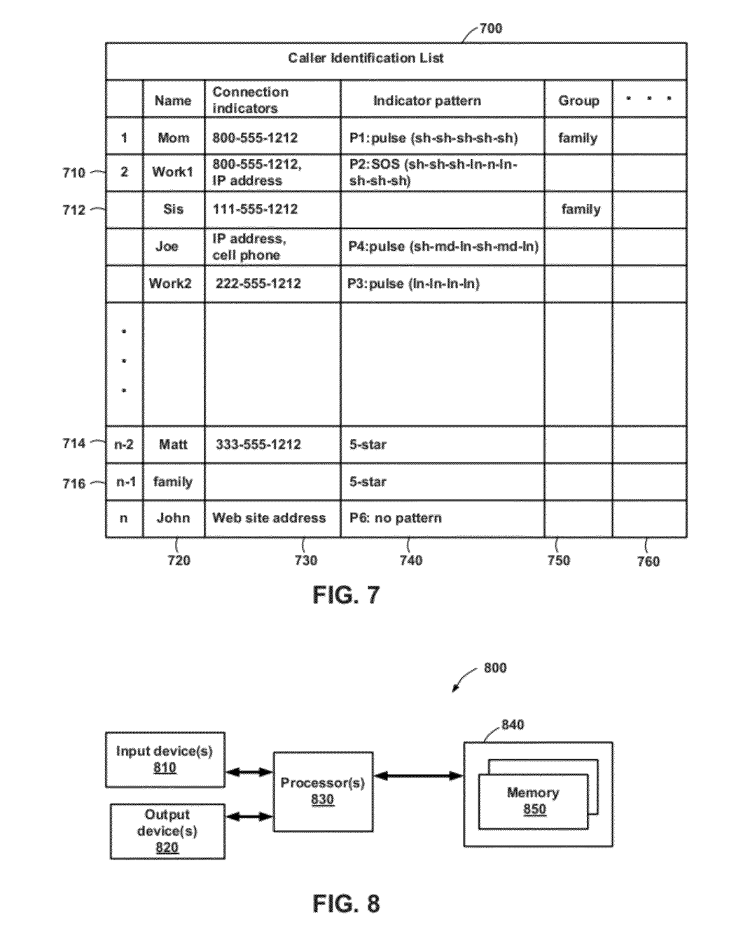

Details of the caller identification list 700 are discussed below with reference to FIG. 7. For the explanation of FIG. 5, it is sufficient to understand that for each entry (e.g., line as shown in FIG. 5) in the caller identification list 700, there is at least one connection indicator 730 and at least one indicator pattern field 740 that may be used for notification to the user of the portable communication device 500. The association logic 556 compares the calling connection indicator to a connection indicator 730 in the caller identification list 700 to determine if there are any matching entries. If there is a matching entry, the association logic 556 determines the identified entry and the associated indicator pattern 740 to be used as a predefined tactile pattern 582 (FIG. 4). The indicator pattern 740 is communicated to the tactile pattern generator 580 to generate the predefined tactile pattern 582. In some embodiments, the indicator pattern 740 may also be communicated to the visual pattern generator 570 to generate a predefined visual pattern 572 correlated to the predefined tactile pattern 582 on the illumination device 574 (FIG. 4), the display 530, or a combination thereof. In some embodiments, the indicator pattern 740 may also be communicated to the audio pattern generator 599 to generate a predefined audio pattern correlated to the predefined tactile pattern 582 on a speaker or other audio output.

For example, if the calling connection indicator matches ID #1, the first entry in the caller identification list 700 is the identified entry and the associated indicator pattern 740 is pattern “A.” If the calling connection indicator matches ID #N, the last entry in the caller identification list 700 is the identified entry and the associated indicator pattern 740 is pattern “N.” If the calling connection indicator does not match an entry in the caller identification list 700, a default indicator pattern 740 may be chosen and, as a result, a default tactile pattern may be generated by the tactile pattern generator 580.

Users of the portable communication device 500 can specify within their caller identification list 700 what tactile patterns to associate with what connection indicators. In some embodiments, this association may be part of a standard contact list of the portable communication device 500. In other embodiments a separate contact list with the associations may be created and maintained.

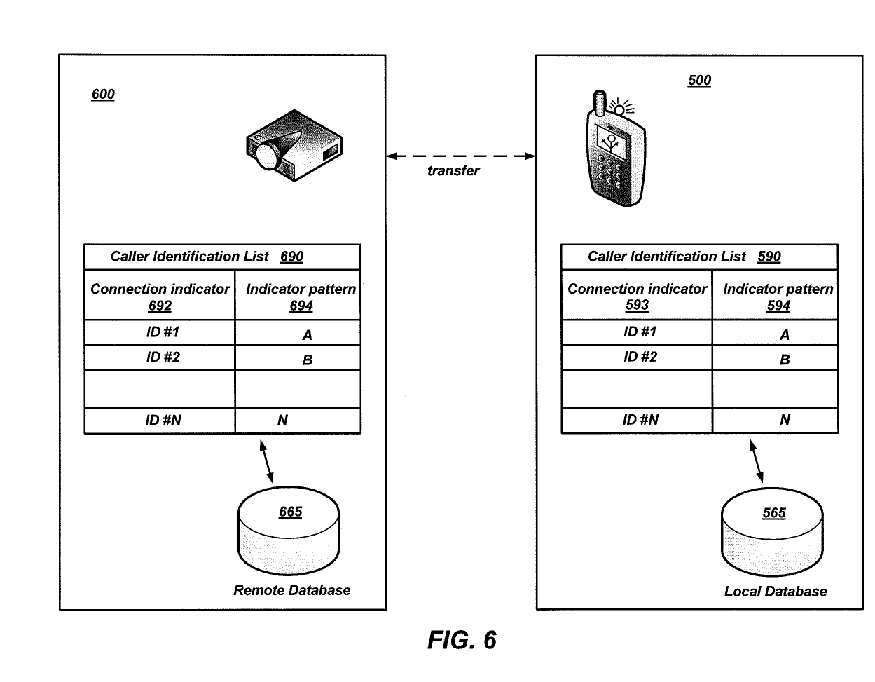

FIG. 6 is a block diagram illustrating communication of caller identification information between an additional communication device 600 and a portable communication device 500. A caller identification list 690 may be maintained, created, or a combination thereof on the additional communication device 600 and stored in a remote database 665. The caller identification list 690 would include at least a connection indicator field 692 and an indicator pattern field 694 for each entry.

A caller identification list 590 may be maintained, created, or a combination thereof on the portable communication device 500 and stored in a local database 565. The caller identification list 590 would include at least a connection indicator field 593 and an indicator pattern field 594 for each entry.

Furthermore, the additional communication device 600 and portable communication device 500 may communicate to transfer information about their caller identification lists 690, 590 therebetween. In this way, the caller identification lists 690, 590 between the additional communication device 600 and the portable communication device 500 may be synchronized after changes are made to one of the caller identification lists 690, 590. Moreover, while not illustrated in FIG. 6, a caller identification list may also exist on the contact storage 465 (FIG. 4) of the VRS 450. Portions or all of the caller identification list in the contact storage 465 of the VRS 450 may be communicated to the caller identification list 590 on the portable communication device 500, the caller identification list 690 on the additional communication device 600, and combinations thereof. As a result, the various caller identification lists between various communication devices (e.g., 500 and 600) may be reconciled with the caller identification list in the contact storage 465 of the VRS 450.

FIG. 7 is a block diagram illustrating entries in a caller identification list 700 in accordance with one or more embodiments of the invention. This caller identification list 700 is a more detailed, but general description of what may be included in the caller identification list on the VRS 450 and the caller identification list 590 on the portable communication device 500.

A contact name field 720 may be included, a field for the connection indicators 730 is included, a field for the indicator patterns 740 is included, and many other fields 760 may be included for the convenience of the user. The indicator patterns 740 may be a variety of patterns for alerting the user through at least the tactile pattern generator 580 and possibly including the audio pattern generator 599 and the visual pattern generator 570 (FIG. 5). The patterns illustrated in FIG. 7 comprise vibrations of different durations including short (sh), medium (md), and long (ln). Of course, other patterns and durations may be used. In addition, durations of blank time between the vibrations may be variable. Moreover, if a portable communication device 500 is so equipped, the vibration patterns may also include different frequencies of vibration. In such a system, when the audio pattern generator 599 is also used, different tones could be associated with the different vibration frequencies and when the visual pattern generator 570 is also used, different colors could be associated with the different vibration frequencies.

FIG. 7 also indicates an identified entry 710, which would be selected when the calling connection indicator matches with the connection indicator 730 for the Work1 entry. As a result, the pattern P3 would be used as the vibration pattern for the tactile pattern generator 580.

As non-limiting examples, indicator patterns 740 may be configured with a rating system enabling the user to rate contacts from 1 to 5 stars. For example, this rating system may be defined as a label or mnemonic for any particular indicator pattern. Thus if a user rated someone as a 5-star contact, the tactile pattern generator 580 would vibrate a pattern association with the 5-star label (e.g., 5 short buzzes followed by a pause), while a 2-star contact would have a different indicator pattern 740 associated with that label (e.g., buzz 2 short buzzes followed by a pause). This rating system may be used, for example, for users to determine their interest in answering the call without having to look at the phone.

As a more general example, the user may associate a contact with a group and then the user may associate that group to an indicator pattern 740. The group field 750 indicates an identification of a contact 720 with a specific group 750. For example, the user could have groups that are labeled 1-star, 2-star, 3-star, family, etc. The user could then create a group entry 716 and associate an indicator pattern 740 with the group. For example, the user might create a group entry 716 called “family” and assign the 5-star label to the “family” group. The 5-star label may be a mnemonic for a specific indicator pattern (e.g., P4). With this type of association, the user could easily change the indicator pattern 740 associated with the 5-star label to a different pattern and all of the entries associated with the group entry 716 would then use the new indicator pattern. In addition, the user could easily change the label associated with the group entry 716 to a different label and thereby changing the indicator pattern 740 that is associated with the group entry 716.

In addition, labels may be used in the indicator pattern 740, rather than the actual pattern. Thus, label 5-star may be associated with an individual entry 714 and a group entry 716. Of course, the linking between a group, individual contacts, and indicator patterns may be performed in many different ways within the scope of embodiments of the present invention. As a non-limiting example, different data files or databases may be used between the labels, groups, individuals, and indicator patterns to create the desired associations.

As another non-limiting example, for users who can discern more complex patterns, a coding for alphanumeric characters, such as Morse code, may be used to indicate the calling connection indicator as the telephone number or spell out the contact's name. An example of such a coding is illustrated as generating the Morse code for S-O-S in pattern P2.

As another non-limiting example, the user may define different patterns for different groups of people, such as one pattern for contacts associated with work, another pattern for contacts associated with family, and another pattern for contacts associated with friends. This examples is illustrated in FIG. 7 with pattern P3 being used for both the Work1 contact and the Work2 contact.

FIG. 8 is a block diagram of processing hardware that may be used in accordance with one or more embodiments of the invention. As shown in FIG. 8, an electronic system 800 includes at least one input device 810, at least one output device 820, a memory access device, such as one or more processors 830, and one or more memory devices 840. The memory devices 840 may include at least one semiconductor memory 850.

As non-limiting examples, the memory devices also may include at least one computer-readable medium for storing information, processing instructions, or combinations thereof used in embodiments discussed herein. By way of example, and not limitation, the computer-readable media may include, but is not limited to, magnetic and optical storage devices such as disk drives, magnetic tapes, CDs (compact disks), DVDs (digital versatile discs or digital video discs), and other equivalent storage devices.

As non-limiting examples, input devices 810 may include keyboards, mice, touch-pads, microphones, and communication devices. As non-limiting examples, output devices 820 may include displays, speakers, and communication devices.

The electronic system 800 may be part of a number of computing, processing, and consumer products used in embodiments discussed herein. As non-limiting examples, some of these products may include personal computers, handheld devices, cameras, phones, wireless devices, and displays.

As further non-limiting examples, the voice-capable equipment 412, 422 and video-capable equipment 500, and portable communication device 500 may be configured as the electronic system 800. In addition, computer servers, data servers, or combinations thereof may be configured as the electronic system 500 to implement the processing system 495 of the VRS 450 illustrated in FIG. 4.

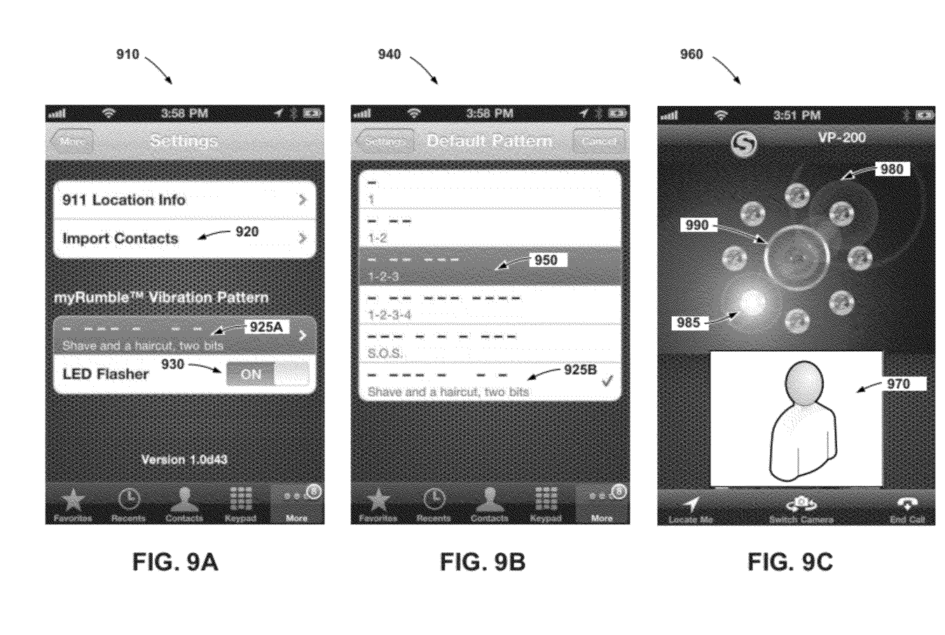

FIGS. 9A-9C illustrate graphical user interfaces that may be used in some embodiments discussed herein. FIG. 9A illustrates a mnemonic (shave and a haircut, two bits) associated with a currently selected indicator pattern 925A. A control 930 illustrates that an illumination device (illumination device 574 in FIG. 4) may be enabled or disabled. A control 920 may be selected to import contacts, reconcile contacts, or a combination thereof, with other devices as explained above when discussing FIG. 6. The selected indicator pattern 925A may be configured as a control that, when selected, brings up a pattern entry window 940.

FIG. 9B illustrates a pattern entry window 940, which may be used to list current patterns, edit current patterns, add patterns, and combinations thereof.

The dashes shown in the pattern entry window 940 may be generated dynamically based on the actual vibration pattern data, such as for example from the caller identification list 700 in FIG. 7. In this example, all the dashes are the same length. However, as discussed above, the dashes may be configured to be different lengths. Likewise, the amount of white space between the dashes can be adjusted to reflect the relative duration of each rest. This view may be thought of as a simplified form of musical notation, much like a drummer would read. It may be simpler and more user friendly to use symbols rather than letters to represent these patterns. In FIG. 9B both the dash-pattern and a textual name for the pattern (i.e., label) are shown. Entry 925B illustrates the currently selected entry and entry 950 illustrates a default entry.

The pattern entry window 940 may also be used to enable a tapping interface to allow users to create a custom vibration pattern. The user would first tap a “Record” button, and then tap the screen in the desired pattern. The beats may be recorded and can be played back before saving. The user interface would be similar to applications such as for making Voice Notes, but instead of audio data the user interface would save timing, duration, and, potentially, intensity data based on the user's tap inputs.

FIG. 9C illustrates a LIGHTRING® animation window 960. This animation window 960 shows an emulation of a lens 990 and a light group 980. Also illustrated is a video window 970, which may be configured to display video from the video phone 500 (FIG. 5) or video from a device in communication with the video phone 500. The animation window 960 may be configured to emulate other LIGHTRING® configuration, such as, for example those disclosed in U.S. Pat. No. 7,769,141 to Cupal et al., the contents of which is hereby incorporated by reference in its entirety.

As an input method used alone or in combination with the tap interface described above, the user could tap a desired light (one of eight, for example), thereby associating the “beats and rests” directly with a numbered light 985. The resulting pattern would combine and synchronize the vibration data with the visual animation, creating a very distinctive way to see and feel who is calling the user.

Although the present invention has been described with reference to particular embodiments, the invention is not limited to these described embodiments. Rather, the invention is limited only by the appended claims, which include within their scope all equivalent devices or methods that operate according to the principles of the invention as described.

1. A portable communication device, comprising:
incoming caller identification logic configured to capture a calling connection indicator from an incoming call;
a caller identification list configured to store therein one or more entries, each of the one or more entries including one or more connection indicators associated with an entry and a predefined tactile pattern associated with an entry;
association logic configured to determine an identified entry in the caller identification list by matching the calling connection indicator to the one or more connection indicators associated with the identified entry; and
a tactile pattern generator configured to generate a plurality of tactile patterns for the portable communication device, the plurality of tactile patterns comprising:
the predefined tactile pattern associated with the identified entry in the caller identification list; or
a default tactile pattern if the calling connection indicator does not correlate to any of the one or more connection indicators in the caller identification list.

2. The portable communication device of claim 1, wherein:
the caller identification list is further configured to store therein a group identification for one or more of the entries and the one or more entries include at least one group entry; and
the association logic is further configured to determine the identified entry by matching the calling connection indicator to the at least one group entry.

3. The portable communication device of claim 1, wherein the tactile pattern generator is further configured to generate vibration of the portable communication device.

4. The portable communication device of claim 3, wherein the tactile pattern generator is configured to generate the vibration with patterns of vibration and no vibration correlated to the predefined tactile patterns associated with the one or more entries of the caller identification list.

5. The portable communication device of claim 4, wherein the predefined tactile patterns associated with the one or more entries of the caller identification list comprise sequences of patterns wherein each pattern in the sequences represents an alphanumeric character.

6. The portable communication device of claim 4, wherein the predefined tactile patterns associated with the one or more entries of the caller identification list comprise a repeating sequence of vibration durations selected from the group consisting of short durations, medium durations and long durations.

7. The portable communication device of claim 1, wherein the incoming call detection logic is configured to compatibly couple with a wireless network for detecting the incoming call.

8. The portable communication device of claim 7, wherein the wireless network is selected from the group consisting of a cellular telephone network and an Internet Protocol network.

9. The portable communication device of claim 1, further comprising:
a user interface configured for capturing outgoing image sequences and displaying incoming image sequences suitable for person-to-person communication using gestures; and
a communication element configured for sending the outgoing image sequences and receiving the incoming image sequences.

10. The portable communication device of claim 1, further comprising an audio generator configured to generate an audible indicator correlated to the calling connection indicator.

11. The portable communication device of claim 10, further comprising an audio pattern generator and wherein the audible indicator is a predefined audible pattern further correlated to the predefined tactile pattern.

12. The portable communication device of claim 1, further comprising:
an illumination device; and
a visual pattern generator configured to generate predefined visual patterns on the illumination device, each of the predefined visual patterns correlated to the predefined tactile patterns.

13. The portable communication device of claim 12, wherein the illumination device is at least one of an illuminatable element and a display.

14. A method of indicating an incoming call on a portable communication device, comprising:
capturing a calling connection indicator from an incoming call;
selecting an identified entry from a caller identification list comprising one or more entries, wherein each of the one or more entries is associated with a contact of a user of the portable communication device and includes one or more connection indicators for the contact and a tactile pattern for the contact and the identified entry is selected by matching the calling connection indicator to one of the one or more connection indicators;
generating a tactile pattern for the portable communication device, the tactile pattern comprising:
a predefined tactile pattern associated with the identified entry in the caller identification list; or
a default tactile pattern if the calling connection indicator does not correlate to any of the one or more connection indicators in the caller identification list.

15. The method of claim 14, wherein selecting the identified entry further comprises selecting a group entry from the caller identification list by matching the calling connection indicator to the group entry.

16. The method of claim 14, further comprising generating the tactile pattern as a vibration of the portable communication device.

17. The method of claim 16, further comprising generating the vibration with patterns of vibration and no vibration correlated to the predefined tactile patterns associated with the one or more entries of the caller identification list.

18. The method of claim 17, wherein the predefined tactile patterns associated with the one or more entries of the caller identification list comprise sequences of patterns wherein each pattern in the sequences represents an alphanumeric character.

19. The method of claim 17, wherein the predefined tactile patterns associated with the one or more entries of the caller identification list comprise a repeating sequence of vibration durations selected from the group consisting of short durations, medium durations and long durations.

20. The method of claim 14, wherein capturing the calling connection indicator includes receiving a call from a wireless network.

21. The method of claim 20, wherein receiving the call from the wireless network comprises an act selected from the group consisting of a receiving a call on a cellular telephone network and receiving a call on an Internet Protocol network.

22. The method of claim 14, further comprising:
capturing outgoing image sequences suitable for person-to-person communication using gestures;
sending the outgoing image sequences through a video-capable network;
receiving incoming image sequences through the video-capable network; and
displaying the incoming image sequences suitable for person-to-person communication using gestures.

23. The method of claim 14, further comprising generating an audible indicator correlated to the calling connection indicator.

24. The method of claim 23, further comprising generating the audible indicator as a predefined audible pattern correlated to the predefined tactile pattern.

25. The method of claim 14, further comprising generating a predefined visual pattern on an illumination device, the predefined visual pattern correlated to the predefined tactile pattern.

26. The method of claim 25, wherein generating the predefined visual pattern on an illumination device comprises presenting the predefined visual pattern on a display of the portable communication device.

27. The method of claim 14, further comprising:
establishing a communication link with an additional communication device; and
reconciling a caller identification list on the additional communication device with the caller identification list on the portable communication device.

28. A relay service for a hearing-impaired user, comprising:
a caller identification list with one or more entries, each of the one or more entries associated with a contact of the hearing-impaired user and including one or more connection indicators for the contact and a predefined tactile pattern associated with the with an entry; and
communication logic configured to convey information between the relay service and a portable communication device, the information including at least one of the one or more entries in the caller identification list.

29. The relay service of claim 28, wherein the communication logic is further configured to convey information between the relay service and video-capable equipment and further comprising a processing system configured to reconcile caller identification lists on each of the relay service, the video-capable equipment, and the portable communication device.

30. A portable communication device, comprising:
a user interface configured to:
indicate a caller identification list with one or more entries, each of the one or more entries associated with a contact of a user and a tactile pattern associated with an entry; and
enable the user to input a tactile pattern associated with an entry to the caller identification list through a tap interface configured to detect at least a duration of one or more taps and define the tactile pattern correlated to the one or more taps.

31. The portable communication device, of claim 30, wherein
the user interface is further configured to:
present a light pattern on a display of the portable communication device; and
the tap interface is further configured to detect the one or more taps as taps in a vicinity of one or more lights in the light pattern.
